(19) United States
(12) Patent Application Publication
(10) Pub. No.: US 2006/0049283 A1
(43) Pub. Date: Mar. 9, 2006

(54) Multi-purpose water sprayer in horticulture

(76) Inventor: Duck-Shin Lee, Seoul (KR)

Correspondence Address: MATHEWS, SHEPHERD, MCKAY, & BRUNEAU, P.A., 100 THANET CIRCLE, SUITE 306, PRINCETON, NJ, 08540, US

(21) Appl. No.: 11/081,226

(22) Filed: Mar. 16, 2005

(30) Foreign Application Priority Data
Aug. 19, 2004 (KR) 2004-0065472

(51) Int. Cl. B05B 9/01

(52) U.S. Cl. 239/526; 239/525; 239/587.1; 239/587.4; 239/587.5

(57) ABSTRACT

The present invention relates to a multi-purpose water sprayer in horticulture that is used as connecting to water pipe, more particularly a multi-purpose water sprayer in horticulture which increase a effect of water spray by increasing a water pressure at a point passing this water sprayer, can save water when spraying at crops in horticulture and be operated easily, may spray water in a spreading state from a stop state by declining a spouting angle to inward and then can control a strength and an amount of a sprayed water according to an angle, and can obtain an effect turning to a straight function or a spraying function.

### FIELD OF THE INVENTION

The present invention relates to a multi-purpose water sprayer in horticulture, more particularly a multi-purpose water sprayer in horticulture which increase a effect of water spray by increasing a water pressure at a point passing this water sprayer, can save water when spraying at crops in horticulture and be operated easily, may spray water in a spreading state from a stop state by declining a spouting angle to inward and then can control a strength and an amount of a sprayed water according to an angle, and can obtain an effect turning to a straight function or a spraying function.

### BACKGROUND ART

Conventional water sprayer 10 has a hose connecting part 2 at its one end connecting a hose, a handgrip 4, and a valve of handgrip-type 6 positioned at outside of a handgrip 4 that can control a strength and an amount of a sprayed water, thereby when controlling a water this conventional water sprayer has inconvenient problem that it need a continuous gripping of a handgrip to spray water, even though it can be sprayed continuously by a spray fitting loop 8.

### SUMMARY OF THE INVENTION

Therefore, it is an object of the present invention to solve the above problem of a prior art. The object of the present invention is to provide a multi-purpose water sprayer in horticulture which increase a effect of water spray by increasing a water pressure at a point passing this water sprayer under a general water pressure state, can save water when spraying at crops in horticulture and be operated easily, may spray water in a spreading state from a stop state by declining a spouting angle to inward and then can control a strength and an amount of a sprayed water according to an angle, and can obtain an effect turning to a straight function or a spraying function.

In accordance with the present invention, the above object of the present invention can be achieved by providing a multi-purpose water sprayer in horticulture constructed with;
a rotary-type water spraying part varying to straight function or a spraying function to one side;
a handgrip portion having therein a conduit in which is flowed water through a hose connecting part and having a groove controlling an amount of water at the opposing side with the above rotary-type water spraying part;
a spraying connecting part having the first rotary part connecting the above rotary-type water spraying part with the above handgrip portion;
the second rotary part formed at one side of the above handgrip portion and rotating with the state being connected with the above first rotary part of spraying part; and
a rubber valve being formed a groove to generate a fluid pressure by connecting the above conduit of handgrip portion with the above second rotary part, being jointed the above first rotary part and the above second rotary part and folded with a determined angle.

### BRIEF DESCRIPTION OF THE DRAWINGS

Other objects and aspects of the present invention will become apparent from the following description of embodiments with reference to the accompanying drawing in which:

FIG. 1 depicts a water sprayer in horticulture according to prior art;

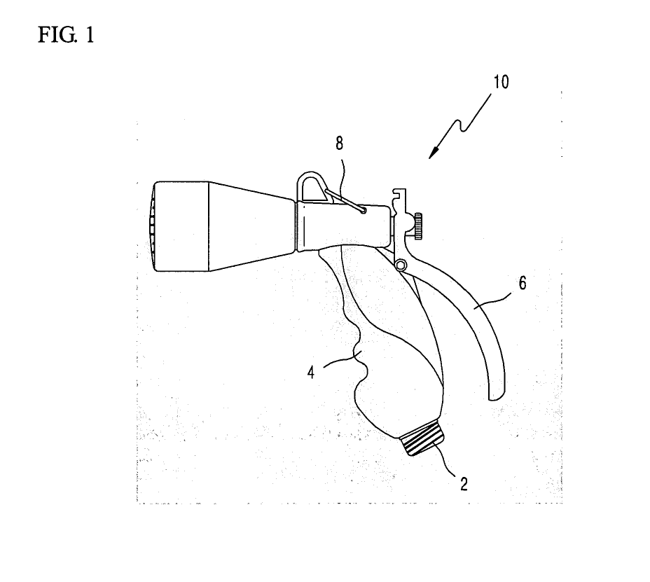

FIG. 2 is a perspective view representing a disassembled state of a multi-purpose water sprayer in horticulture according to the present invention;

FIG. 3 is a side view representing a multi-purpose water sprayer in horticulture according to the present invention;

FIG. 4 is a cross-section view representing a multi-purpose water sprayer in horticulture according to the present invention;

FIG. 5 is a perspective view representing a folded state of a multi-purpose water sprayer in horticulture according to the present invention;

FIG. 6 depicts a side cross-section view representing a folded state of a multi-purpose water sprayer in horticulture according to the present invention;

FIG. 7 represents a side view of other embodiment of a multi-purpose water sprayer in horticulture according to the present invention;

FIG. 8 represents a side view of another embodiment of a multi-purpose water sprayer in horticulture according to the present invention;

FIG. 9 represents a side view of another embodiment having a spring of a multi-purpose water sprayer in horticulture according to the present invention;

FIG. 10 represents a side view of another embodiment having a spring of a multi-purpose water sprayer in horticulture according to the present invention in a folded state;

FIG. 11 represents a side view of another embodiment of a multi-purpose water sprayer in horticulture according to the present invention;

FIG. 12 represents a side view of another embodiment having a spring of a multi-purpose water sprayer in horticulture according to the present invention in a folded state.

### BEST MODE FOR CARRYING OUT THE INVENTION

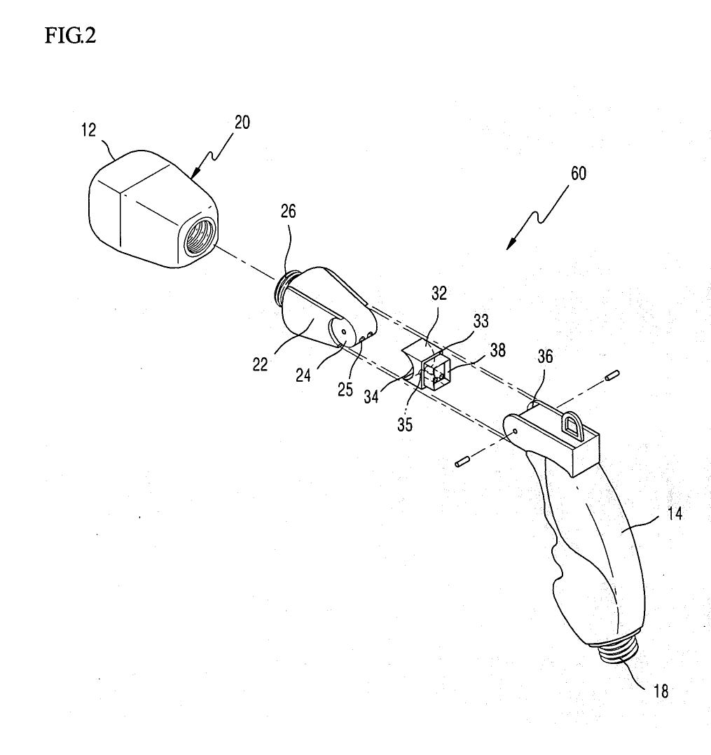

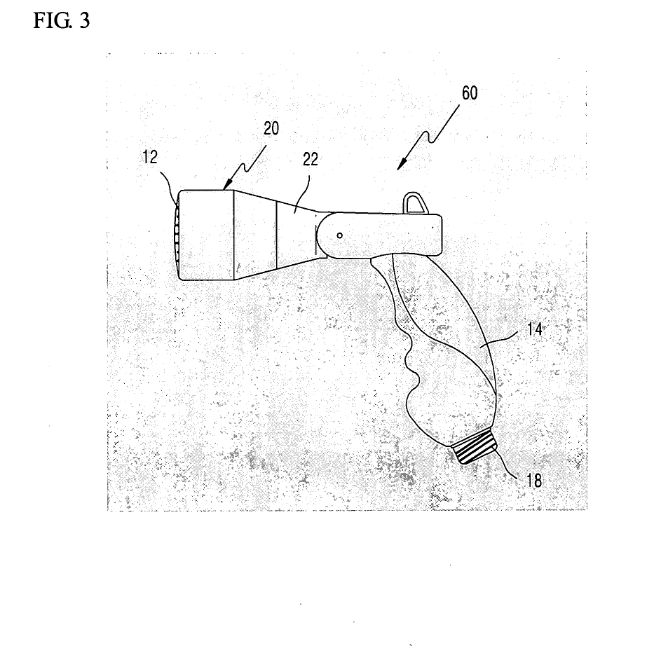

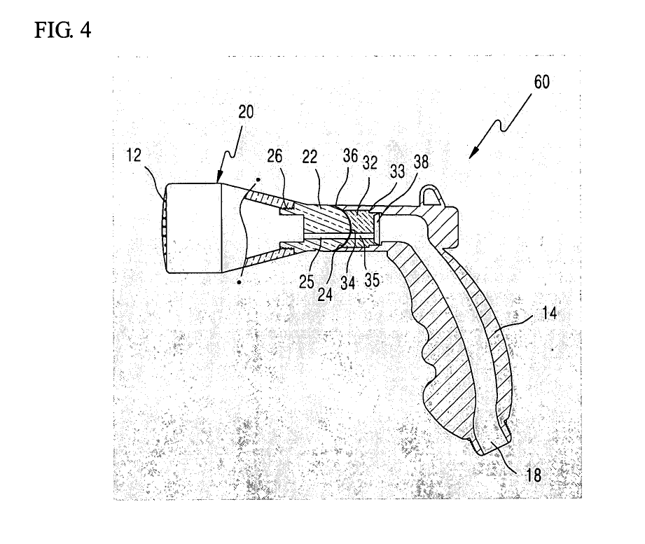

FIG. 2 is a perspective view representing a disassembled state of a multi-purpose water sprayer in horticulture according to the present invention, FIG. 3 is a side view representing a multi-purpose water sprayer in horticulture according to the present invention, FIG. 4 is a cross-section view representing a multi-purpose water sprayer in horticulture according to the present invention.

A multi-purpose water sprayer in horticulture 60 according to the present invention is consisted of a rotary-type water spraying part 20, a handgrip portion 14, a spraying connecting part 22, and rubber valve 32, and then constructed to be sprayed in the state being controlled a spraying strength by bending.

Wherein, the above rotary-type water spraying part 20 have a function that enable water to spray with straight or dispersed form due to rotating it to right or left direction, and a hose connecting portion 18 is formed at the other end of a handgrip portion 14 being flowed in water, opposing with the above rotary-type water spraying part 20.

The above handgrip portion 14 has a conduit in which is flowed water through a hose connecting portion 18 at therein.

The above handgrip portion 14 is preferably formed to have a indentation at one side to grasp easily.

And, at one side being connected with handgrip portion 14, the first rotary portion 24 having a shape of semi-circle is formed, and at the other side, a spraying connecting part 22 that is jointed with a threaded connecting portion 26 being threaded with the above rotary-type water spraying part 20 is formed.

The spraying connecting part 22 is formed at one side of a handgrip portion 14 by the second rotary portion 34 forming a groove of semi-circle being connected with the first rotary portion 24 having a shape of semi-circle.

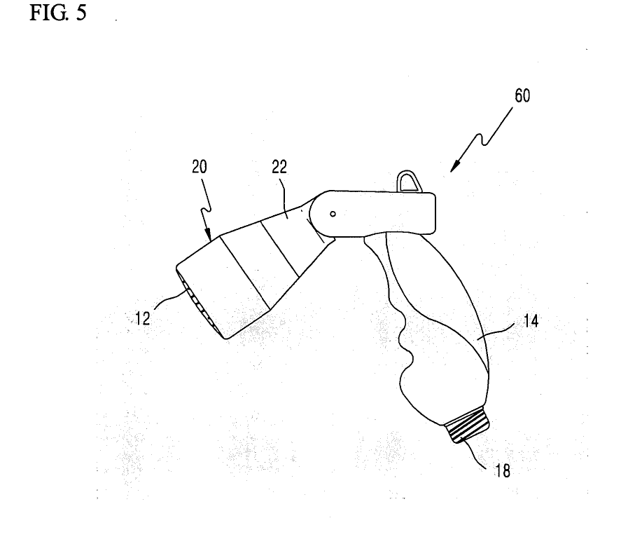

The above first rotary portion 24 and the second rotary portion 34 can be bended by a determined angle to control a strength of a sprayed water, as seen FIG. 5.

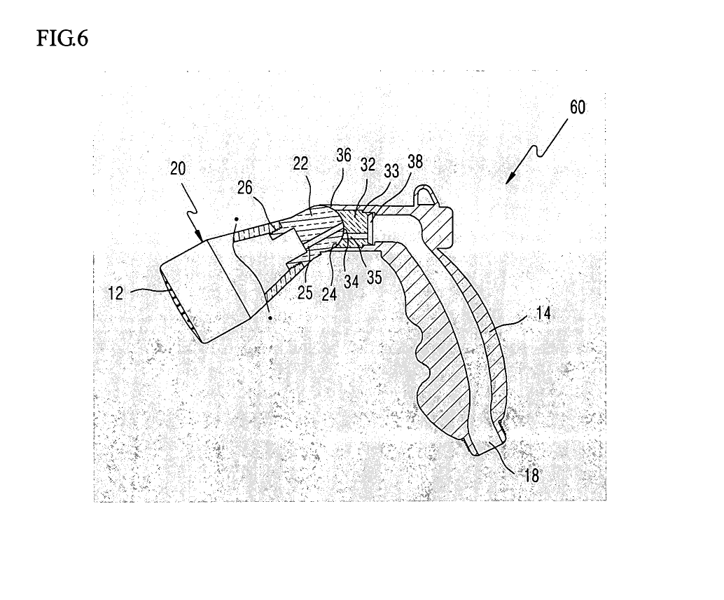

At this time, the above first rotary portion 24 and the second rotary portion 34 can be bended to inward direction but outward direction by forming rotary checking step 36 and positioning a rubber valve 32 at its position, as seen FIG. 6.

The above rubber valve 32 connect the first rotary portion 24 and the second rotary portion 34, and have a groove to generate a fluid pressure by connecting a conduit with a pathway of a hose connecting part 18 of a handgrip portion 14.

Wherein, the above conduit of a handgrip portion 14 and a valve conduit 35 of a rubber valve 32 are situated on a leaner line.

The one side of the above rubber valve 32 adhere closely to one side of the first rotary portion 24, and the other side of the above rubber valve 32 entirely adhere to inside of a conduit 25 and a checking step 33 preventing a pushing backward and a twisting, and then have a sealing wing 38 that is more thin to forward to the edge, thereby adhering closely to an inside.

It is also included in the present invention to have a rubber valve 32 being formed with platen side resulted from cutting off the above sealing wing 38.

Furthermore, the above valve conduit 35 of a rubber valve 32 can be prepared with a various shape of a square or a circle, the number of the above valve conduit 25 also can be one or more than one, the size of the above valve conduit 25 can be selected optionally, and several valve conduit 25 can be installed to correspond to control of a fluid pressure.

When the above rubber valve 32 is installed on the same line with a spraying connecting part 22, the passages of the above valve conduit 35 of a rubber valve and the above connecting conduit 25 of spraying connecting part 22 are opened therefore a water is sprayed, and when a spraying part 20 is bended, a flow of water is cut off.

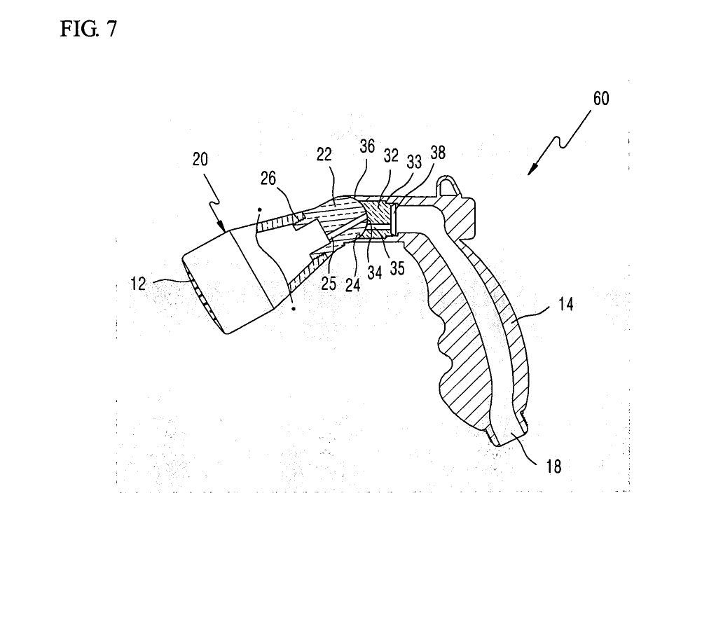

Another embodiment of a multi-purpose water sprayer in horticulture 60 according to the present invention is represented in FIG. 7. According to this embodiment, as seen FIG. 7, a rubber valve 32 which is the first rotary portion 24 having a checking step 33 is inserted symmetrically with a spraying connecting part 22, and at the other end, the second rotary portion 34 is harmonized with a handgrip portion 14, thereby can being bended.

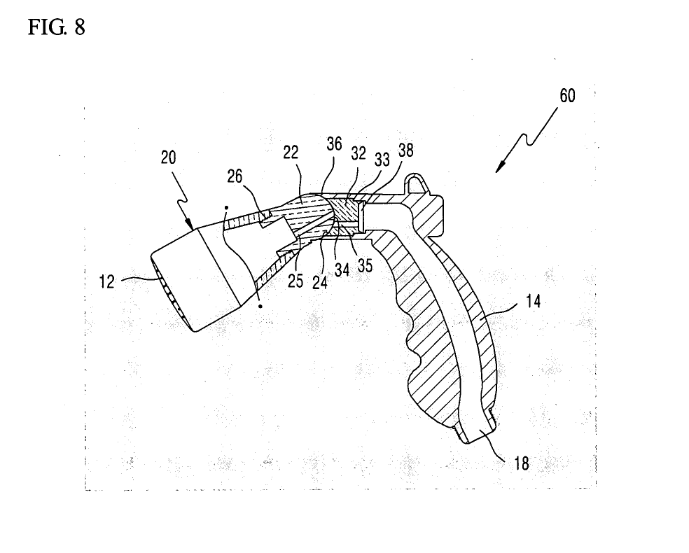

And, as seen FIG. 8, a rubber valve 52 of platen form which is the first rotary portion 24 no having a checking step 33 is positioned at a spraying connecting part 22, and at the other end, a connecting portion 56 which is the second rotary portion 34 made of synthetic resin is positioned, and a rubber ring 54 is inserted to seal a gap of a connecting portion 56.

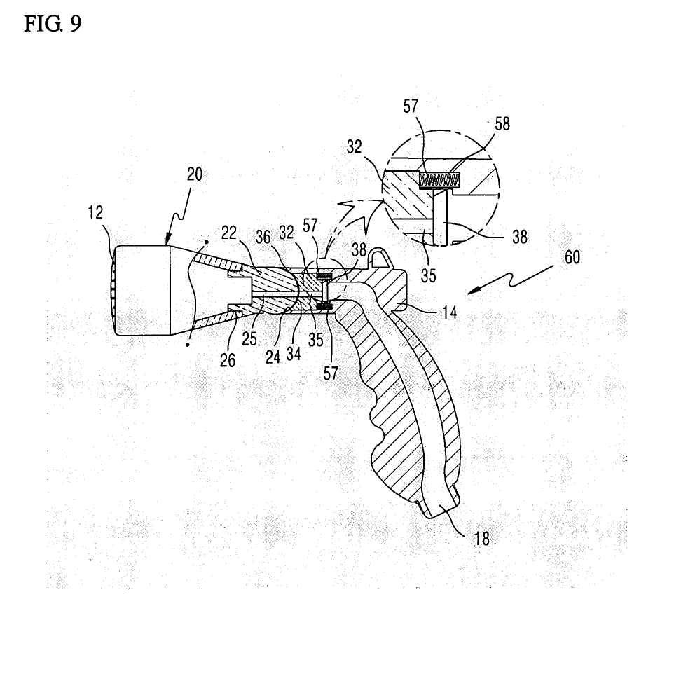

Another embodiment of a multi-purpose water sprayer in horticulture 60 according to the present invention is represented in FIG. 9. According to this embodiment, as seen FIG. 9, a spring groove 58 is formed at a body of handgrip portion 14 and a checking step 33, and by inserting a spring, the spring 57 push a rubber valve 32, therefore it is possible to adhere closely the first rotary portion 24 and a rubber valve 32.

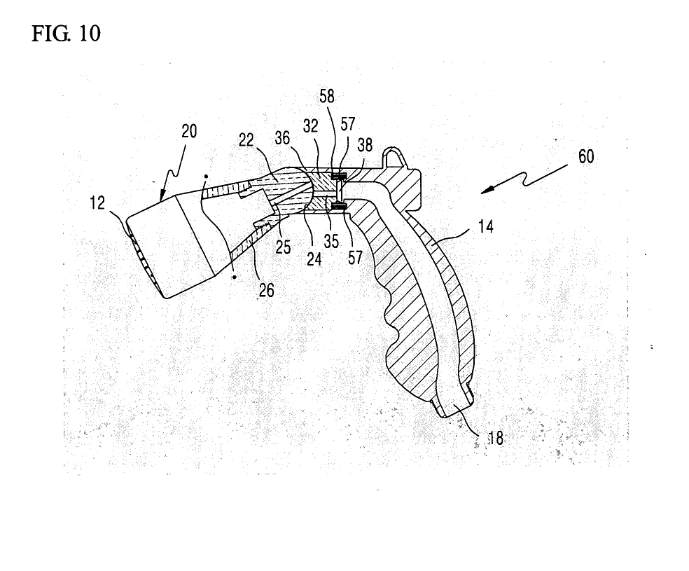

At this time, a spring 57 is designed to enable to adhere close to a rubber valve 32 by strong urging power, as seen FIG. 10.

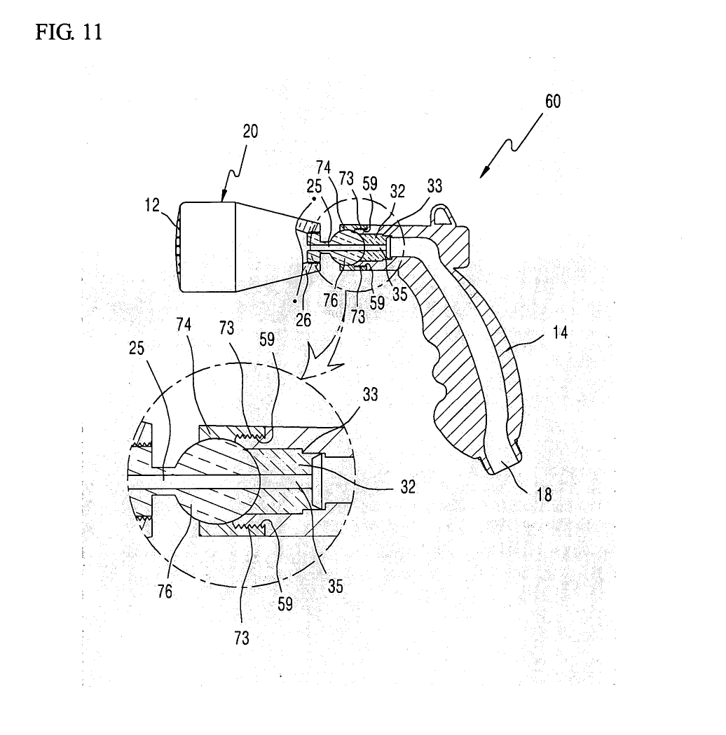

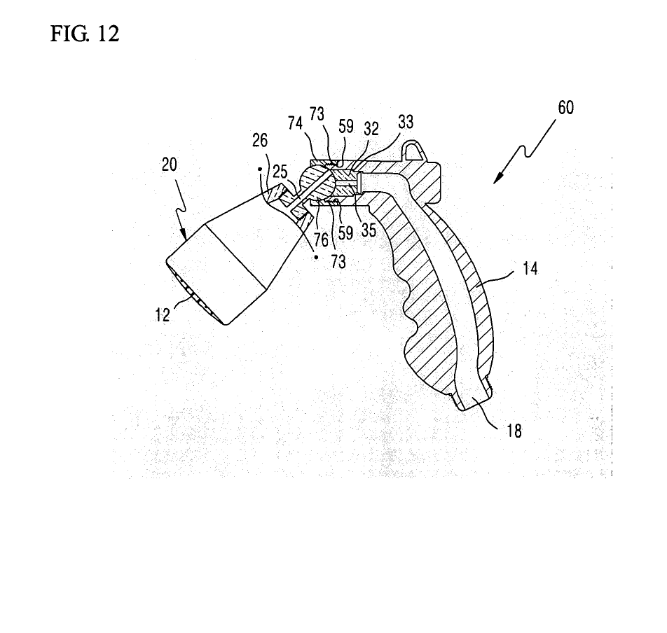

Furthermore, another embodiment of a multi-purpose water sprayer in horticulture 60 according to the present invention is represented in FIG. 11. According to this embodiment, as seen FIG. 11, after body thread line 59 is formed at one side of a handgrip portion 14, a rubber valve 32 is positioned and a rotary-type water spraying part 20 is jointed, thereby forming a angle controller 76 of circle shape. And it is possible to control an angle by fixing a connecting thread line 73 of a circle auxiliary frame 74 to a body thread line 59 of a handgrip portion 14 by binding, as seen FIG. 12.

By this configuration, an angle of the above rotary-type water spraying part 20 cab be controlled with all direction, thereby it can be to control an amount of water by bending with all direction.

Furthermore, a spring groove 58 is formed at a sprayer body that form a circle auxiliary frame 74 having a angle controller 76 of circle shape in the state of jointing a rotary-type water spraying part 20 and then a spring 57 can be installed.

Next, it will be described in details for the present invention to operate.

First, user grasp a handgrip portion 14 and then connect a general hose to a hose connecting portion 18, and unfold a rotary-type water spraying part 20 straightly, thereby water is sprayed from the above spraying part 20. At this time, by rotating the above spraying part 20 to right or left, it is possible to select a straight function or a spraying function.

On the other hand, according to the angle of bending the above rotary-type water spraying part 20 to inward, it can be to control an amount of water and strength of sprayed water, when totally bending the above rotary-type water spraying part 20 to inward, it can be to stop spraying water.

The above rubber valve 32 can be prepared with a shape of a square or a circle according to a frame of water sprayer, and a sealing wing 38 entirely adhere close to a inside of a valve conduit 35 by flowing pressure of water thereby achieving to prevent a leak of water, and the second rotary portion 34 of a rubber valve 32 entirely adhere close to the first rotary portion 24 thereby operating a spraying or stopping of water. Furthermore, even though a gap between the first rotary portion 24 and the second rotary portion 34 is occurred by using for a long time, a close adhering is obtained by flowing pressure of water thereby achieving to prevent a leak of water.

Moreover, a multi-purpose water sprayer in horticulture 60 according to the present invention has a rotary-type water spraying part 20 at one side and has a hose connecting portion at the other end opposing to the above rotary-type water spraying part 20, thereby this configuration a water sprayer can spray a little of water by unfolding a spraying part 20 from entirely folding angle to about 30 degree and spray a great quantity of water by reaching to 180 degree. Also, water is not sprayed because a flowing pressure of water is strength and a valve conduit 35 of a rubber valve 32 do not coincide with a connecting conduit 25 of a spray connecting part as seen FIG. 5, and if a rubber valve 32 coincide with a spray connecting part 22 and a passage for water is opened, a flowing pressure of water is more weak than the case of FIG. 5, therefore more great quantity of water is sprayed.

As describing in the above, a multi-purpose water sprayer in horticulture according to the present invention increase a effect of water spray, and can save water when spraying at crops in horticulture and reduce a manufacturing cost and can exchange partially and can be operated easily, may spray water in a spreading state from a stop state by declining a spouting angle to inward and then can control a strength and an amount of a sprayed water according to an angle, and also can obtain an effect turning to a straight function or a spraying function.

What is claimed is:

1. A multi-purpose water sprayer being connected a hose connecting portion to a hose and having a valve of handgrip shape to control sprayed water, comprising;
a rotary-type water spraying part 20 varying to straight function or a spraying function to one side of the above hose connecting portion 18;
a handgrip portion 14 having therein a conduit in which is flowed water through the above hose connecting portion 18 and having a groove controlling an amount of water at the opposing side with the above rotary-type water spraying part 20;
a spraying connecting part 22 having the first rotary part 24 connecting the above rotary-type water spraying part 20 with the above handgrip portion 14;
the second rotary part 34 formed at one side of the above handgrip portion 14 and rotating with the state being connected with the above first rotary part 24 of spraying connecting part 22; and
a rubber valve 32 being formed a groove to generate a fluid pressure by connecting the above conduit of handgrip portion 14 with the above second rotary part 34,
wherein, the above first rotary part 24 and the above second rotary part 34 being jointed and folded with a determined angle.

2. The multi-purpose water sprayer of claim 1, wherein the above spraying connecting part 22 is jointed with the above rotary-type water spraying part 20 by threaded connecting at one side, and at the other side of a threaded connecting portion 26, the first rotary portion 24 having a shape of semi-circle is jointed with the above second rotary part 34.

3. The multi-purpose water sprayer of claim 2, wherein the above handgrip portion 14 has a spring groove 58 and a spring 57 urge the above a rubber valve 32 to prevent from leaking of water by folding between the first rotary portion 24 and the second rotary part 34.

4. The multi-purpose water sprayer of claim 1, wherein one side of the above rubber valve 32 have the second rotary part 34 of semi-circle groove shape that adhere closely to the first rotary portion 24, and on the other side, have a sealing wing 38 that protrude in a tiny squire-form and is more thin to forward to the edge, thereby adhering closely to an inside.

5. The multi-purpose water sprayer of claim 4, wherein a checking step 33 and a sealing wing 38 are cut from the above rubber valve 32 and a rubber valve 52 of platen form which have the first rotary portion 24 on one side is formed.

6. The multi-purpose water sprayer of claim 4, wherein the above sealing wing 38 is connected to one side of the above rubber valve 32, and the above sealing wing 38 and the above rubber valve 32 are formed with a square, a circle or a elliptical shape.

7. The multi-purpose water sprayer of claim 5, wherein the above valve conduit 35 of a rubber valve 32 is prepared with a various shape of a square or a circle, the number of the above valve conduit 25 is one or more than one according to a diameter size.

8. A multi-purpose water sprayer characterized in that a body thread line 59 is formed at one side of a handgrip portion 14, a rubber valve 32 is positioned and a rotary-type water spraying part 20 is jointed, thereby forming a angle controller 76 of circle shape, and it is possible for a rotary-type water spraying part 20 to control an angle to all direction by fixing a connecting thread line 73 of a circle auxiliary frame 74 to a body thread line 59 of a handgrip portion 14 by binding.
